(19) United States
(12) Patent Application Publication
(10) Pub. No.: US 2013/0152614 A1
(43) Pub. Date: Jun. 20, 2013

(54) THERMAL MANAGEMENT MODULE AND COOLING SYSTEM COMPRISING SUCH A THERMAL MANAGEMENT MODULE

(71) Applicants: Thomas Traudt, Pegnitz (DE); Michael Bogner, Eckental (DE)

(72) Inventors: Thomas Traudt, Pegnitz (DE); Michael Bogner, Eckental (DE)

(73) Assignee: SCHAEFFLER TECHNOLOGIES AG & CO. KG, Herzogenaurach (DE)

(21) Appl. No.: 13/817,238

(22) PCT Filed: May 31, 2011
(86) PCT No.: PCT/EP2011/058881

§ 371 Date: Feb. 15, 2013

(30) Foreign Application Priority Data
Aug. 17, 2010 (DE) 10 2010 034 484.2

(51) Int. Cl. B60H 1/00

(52) U.S. Cl. CPC B60H 1/00885
USPC 62/196.1

(57) ABSTRACT

A thermal management module for the distribution as required of coolant flows in an electric vehicle, including a valve arrangement (4) having several valves (1, 2, 3). A first valve (1) for connecting a first cooling circuit (5) and a second valve (2) for connecting a second cooling circuit (6) as well as a third valve (3) for connecting a bypass circuit are provided, wherein the bypass circuit (7) allows bypassing a cooler (8) arranged in the first cooling circuit (5). The invention further relates to a cooling system for an electric vehicle having such a thermal management module.

### BACKGROUND

The invention relates to a thermal management module for the distribution as required of coolant flows in an electric vehicle with a valve arrangement comprising several valves. The invention further relates to a cooling system for an electric vehicle with such a thermal management module for the distribution as required of coolant flows to several connected components.

Currently there are various electric vehicles in development. Electric vehicles contain components, such as battery modules, power electronics, and/or electric motors, that must be brought to or held at an operating temperature to ensure their optimum functioning. Here, the different components can have different optimum operating temperatures. To be able to meet these demands, electric vehicles therefore usually have several separate cooling systems or a central cooling system, wherein, however, in the case of the latter, obstacles with respect to the expected performance and/or service life of individually enclosed components must be taken into account.

In addition, cooling circuit runs for internal combustion engines are known that allow a distribution as required and/or mixture of coolant flows.

From the laid open patent application DE 19849492 A1, a coolant circuit of an internal combustion engine is disclosed that is provided with a cooler as a heat exchanger, a coolant pump, and a control element controlling the cooling circuit. The cooling circuit comprises a cooler circuit and a shunt circuit. The control valve of the control element has respective connections for the cooling circuit and for the shunt circuit and also a collecting connection for the feeding or discharge of coolant to the cooler circuit and to the shunt circuit or from the cooler circuit and from the shunt circuit. The control circuit is also provided with a valve element through which a blocked position for the cooler circuit and the shunt circuit, a connection between the cooler circuit or the shunt circuit and the collecting connection, or a connection between the cooler circuit and the shunt circuit to the collecting connection as mixed mode is created selectively. A heating circuit can be further connected that allows a mixed mode between heating and cooling. The proposed cooling circuit should allow several control sizes quickly and without large pressure losses.

### SUMMARY

The present invention is based on the objective of disclosing a thermal management module for an electric vehicle that allows the use of a central cooling system for ensuring an optimum operating temperature for several different components. The thermal management module here should ensure a distribution as required of the coolant flows to the respective components.

The objective is met by a thermal management module according to the invention. Advantageous improvements of the invention are disclosed below. To solve the problem, a cooling system with the features of the invention is also disclosed.

The thermal management module provided for the distribution as required of coolant flows in an electric vehicle has a valve arrangement comprising several valves. According to the invention, a first valve for switching a first cooling circuit and a second valve for switching a second cooling circuit, as well as a third valve for switching a bypass circuit, are provided, wherein the bypass circuit allows a cooler arranged in the first cooling circuit to be bypassed. The proposed thermal management module thus allows a mixed mode that allows a mixing of the coolant flows of the first cooling circuit, the second cooling circuit, and/or the bypass circuit. Furthermore, by means of the two cooling circuits, a distribution of the coolant flows to different components of the electric vehicle can be realized. Such components can be, for example, a battery module, an electric motor, and/or power electronics. Because the optimum operating temperature of a component can deviate from that of a different component, the components are allocated according to their requirements to one of the two cooling circuits, wherein the temperature level of the two cooling circuits is advantageously different. The connection of another cooling circuit is also possible as required.

Preferably the thermal management module also comprises a pump for feeding the coolant. Advantageously, the pump is arranged in a common housing with the valves of the valve arrangement. Alternatively, however, a pump housed in a separate housing can also be provided that can be connected to the thermal management module.

Furthermore, the thermal management module comprises at least one thermal element for cooling and/or heating the coolant. The use of at least one thermal element thus also allows a heating of the coolant, in order to bring, for example, a component of the electric vehicle, in particular, a battery module, quickly to the desired operating temperature for a cold start. To selectively allow a cooling or heating, a thermal element is advantageously arranged in the bypass circuit that allows a bypass of the cooler of the first cooler circuit. A Peltier element can be used, for example, as the thermal element.

The cooling system also disclosed for meeting the objective for an electric vehicle comprises a thermal management module for the distribution as required of coolant flows to several connected components, in particular, a battery module, an electric motor, and/or power electronics, wherein the cooling system comprises at least one cooler in a first cooling circuit and/or in a second cooling circuit, as well as a bypass circuit for bypassing the cooler.

As the component of one such cooling system, here the thermal management module also ensures the distribution as required of the coolant flows to several components. The components advantageously involve a battery module, an electric motor, and/or power electronics. Here, the battery module is connected to the cooling system advantageously via the first cooling circuit or the bypass circuit and the other components via the second cooling circuit. Consequently the coolant flow of the first cooling circuit or the bypass circuit can be fed to the battery module, while the coolant flow of the second cooling circuit is led to the other components.

For feeding the coolant, the cooling system advantageously comprises a central pump. The pump can be part of the thermal management module and here can be arranged within or outside of the housing of the thermal management module. Because the coolant flows can be assembled via the valve arrangement in the thermal management module, one pump is sufficient for several circuits connected to the thermal module.

The cooling system further advantageously comprises at least one thermal element for cooling and/or heating. For example, at least one thermal element could be a Peltier element. Alternatively, the use of other combination heating and cooling devices is also possible. In addition, two thermal elements could also be provided of which one is used for heating and the other is used for cooling the coolant. The thermal element or the thermal elements could also be part of the thermal management module. In addition, the thermal elements could be arranged in a separate housing that can be connected to the thermal management module or in the housing of the thermal management module.

According to one preferred embodiment of the invention, the cooling system comprises a first thermal element for cooling and a second thermal element for heating, as well as a valve arrangement for switching the coolant flows of the thermal elements. If two thermal elements are used, of which one element is responsible for the additional heating power and the other element is responsible as required for the additional cooling power, the activation or deactivation of the required circuits can be realized by means of the additional valve arrangement. The valve arrangement could here comprise a switching valve or alternatively two independently switchable control valves. Advantageously the additional valve arrangement is also part of the thermal management module.

The disclosed thermal management module ensures a distribution as required of coolant flows for the connected components of an electric vehicle through a central cooling system. At the same time, the thermal management module allows a mixed mode that allows, in addition to a cooling of the coolant, also a heating of the coolant. In this regard, the present cooling system with such a thermal management module can also be used for pre-heating a battery module for the cold start of an electric vehicle.

### BRIEF DESCRIPTION OF THE DRAWINGS

Preferred embodiments of the invention are explained in more detail below with reference to the accompanying drawings. Shown are:

FIG. 1 a schematic diagram of a first cooling system according to the invention,

FIG. 2 a schematic diagram of a second cooling system according to the invention, and

FIG. 3 a schematic diagram of a third cooling system according to the invention, each with a thermal management module according to the invention.

### DETAILED DESCRIPTION OF THE PREFERRED EMBODIMENTS

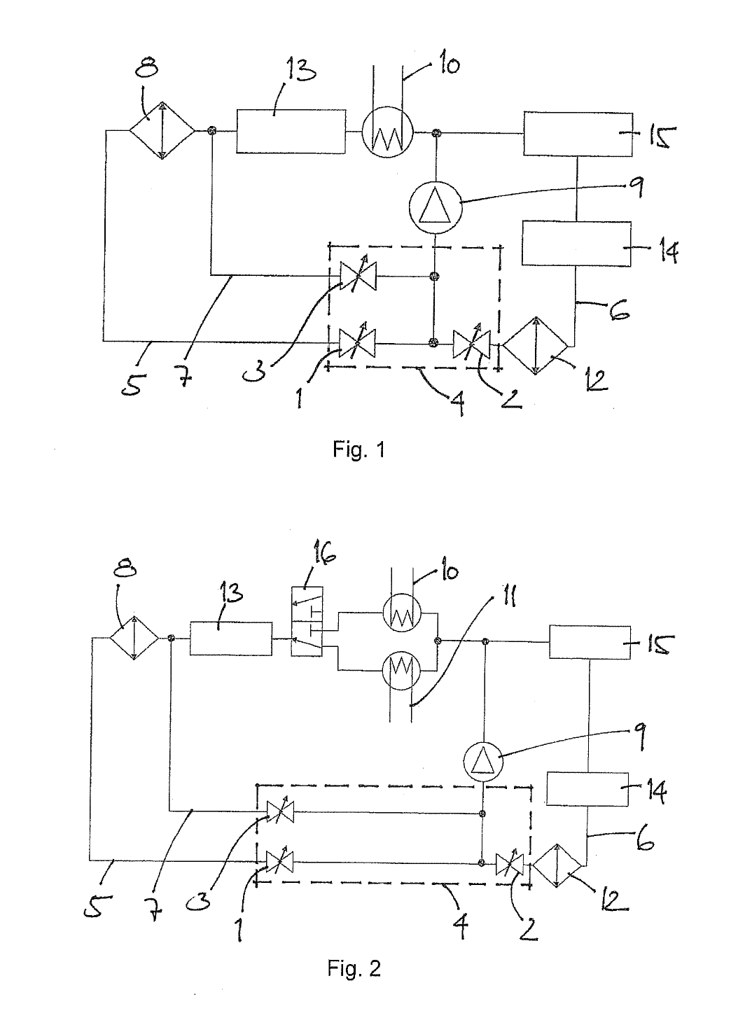

The first embodiment of a cooling system according to the invention shown in FIG. 1 for ensuring the optimum operating temperature of several components 13, 14, and 15 of an electric vehicle comprises a first cooling circuit 5, a second cooling circuit 6, and a bypass circuit 7 whose coolant flows can be switched by means of a valve arrangement 4. The valve arrangement 4 comprises three valves 1, 2, 3 of which each valve is allocated to a cooling circuit or bypass circuit. Thus, according to the switch position of the valves 1, 2, 3 of the valve arrangement 4, a cooling circuit or bypass circuit can be connected or disconnected. The bypass circuit 7 allows the bypassing of a cooler 8 arranged in the first cooling circuit 5, so that a coolant flow that is hotter relative to that of the first cooling circuit 5 can be connected via the bypass circuit 7. Optionally, to also heat the coolant, a thermal element 10 could also be arranged in the bypass circuit 7. To feed the coolant heated via the bypass circuit 7 or cooled via the cooling circuit 5 to a connected component 13, in the present case, to a battery module 13, the cooling system of FIG. 1 also has a pump 9. The pump 9 is arranged in the cooling system such that another pump for the second cooling circuit 6 is unnecessary. Consequently, by means of the pump 9, the coolant is distributed to the two cooling circuits 5, 6 or to the bypass circuit 7. The heating of the coolant is then realized through one or more coolers that are each allocated to the cooling circuits 5, 6 and/or through the thermal element 10 that is arranged in the bypass circuit 7. The components 14, 15 arranged in the second cooling circuit 6 are advantageously an electric motor 14 and power electronics 15 that are provided with cooled coolant by means of a cooler 12 already arranged in the second cooling circuit 6 for the purpose of cooling.

The thermal management module of the cooling system of FIG. 1 comprises at least the three valves 1, 2, 3 of the valve arrangement 4 for switching the coolant flows of the cooling circuits 5, 6 or the bypass circuit 7. In addition, the thermal management module could also comprise the pump 9. It is also possible to integrate the thermal element 10 into the thermal management module. In this way, an especially compact arrangement can be created.

An alternative embodiment of a cooling system according to the invention is shown schematically in FIG. 2. In contrast to the embodiment of FIG. 1, the cooling system has not only one thermal element 10, but also two thermal elements 10, 11 of which the thermal element 10 is used for cooling and the thermal element 11 is used for heating the coolant. By the use of a valve arrangement 16 that is, in the present case, a switching valve, either the thermal element 10 or the thermal element 11 is connected or disconnected. Thus, an additional cooling power or a heating power can be realized, wherein the latter is then advantageously used when the bypass circuit 7 is connected via the valve 3 of the valve arrangement 4 and the first cooling circuit 5 is blocked via the valve 1 of the valve arrangement 4. Thus the component 13 that involves, in turn, a battery module 13, can be supplied with coolant that is selectively heated or cooled such that, for example, at extremely cold temperatures (winter operation), the battery module 13 is preheated. In this case, advantageously only the bypass circuit 7 is active. The second thermal element 11 provides, in contrast, an additional cooling power, by which the battery module 13 can be cooled down further, if the cooling power of the cooler 8 is not sufficient.

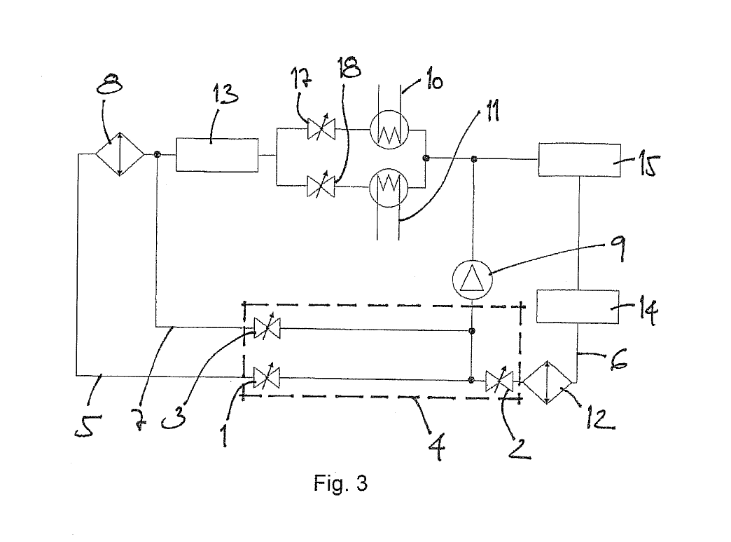

The embodiment of FIG. 3 represents an improvement of the embodiment of FIG. 2 and differs from this in that the valve arrangement 16 comprises, instead of a switching valve, two independently switchable valves 17, 18 in the form of control valves. The valve arrangement 16 thus allows a mixing of the coolant flows of the thermal elements 10, 11, so that the temperature level in the bypass circuit 7 and/or in the first cooling circuit 5 is arbitrarily adjustable.

Independent of the three embodiments shown schematically of a cooling system according to the invention, additional constructions are also possible that require only slight modifications. The invention is also extended to such constructions. For example, the cooler 12 in the second cooling circuit 6 could be eliminated and the cooling power could be realized just by means of the cooler 8 in the first cooling circuit 5. Furthermore, more or fewer components 13, 14, 15 could be connected to the cooling system. Finally, another cooling circuit and/or bypass circuit could be integrated into the cooling system. In this case, the valve arrangement 4 comprises a valve allocated to the additional cooling circuit, in order to connect or disconnect this additional circuit.

### LIST OF REFERENCE NUMBERS

1 Valve
2 Valve
3 Valve
4 Valve arrangement
5 Cooling circuit
6 Cooling circuit
7 Bypass circuit
8 Cooler
9 Pump
10 Thermal element
11 Thermal element
12 Cooler
13 Component, battery module
14 Component, electric motor
15 Component, power electronics
16 Valve arrangement
17 Valve
18 Valve

1. Thermal management module for distribution of coolant flows in an electric vehicle comprising a valve arrangement with several valves, including a first valve for switching a first cooling circuit, a second valve for switching a second cooling circuit, and a third valve for switching a bypass circuit, wherein the bypass circuit allows a bypass of a cooler arranged in the first cooling circuit.

2. Thermal management module according to claim 1, further comprising a pump for feeding the coolant.

3. Thermal management module according to claim 1, further comprising at least one thermal element for at least one of cooling or heating of the coolant.

4. Cooling system for an electric vehicle with a thermal management module according to claim 1, for the distribution of coolant flows to several connected components, wherein the cooling system comprises at least one cooler in at least one of the first cooling circuit the second cooling circuit and also the bypass circuit for bypassing the cooler.

5. Cooling system according to claim 4, wherein the cooling system further comprises a central pump.

6. Cooling system according to claim 4, wherein the cooling system further comprises at least one thermal element for at least one of cooling or heating.

7. Cooling system according to claim 4, wherein the cooling system further comprises a first thermal element for cooling and a second thermal element for heating and a valve arrangement for switching coolant flows of the thermal elements.

8. Cooling system according to claim 7, wherein the valve arrangement comprises a switching valve or two independently switchable valves.
